(19) United States
(12) Patent Application Publication
(10) Pub. No.: US 2025/0235839 A1
(43) Pub. Date: Jul. 24, 2025

(54) FEEDSTOCK FEEDER SYSTEM

(71) Applicant: SHELL USA, INC., Houston, TX (US)

(72) Inventors: Thomas Koch, Vordingborg (DK); Steffen JANCKER, Hamburg (DE); Gerhard VAN ELBURG, Amsterdam (NL); Zhong Xin CHEN, Beijing (CN)

(21) Appl. No.: 18/866,503

(22) PCT Filed: May 31, 2023
(86) PCT No.: PCT/US2023/067677

§ 371 Date: Nov. 15, 2024

Related U.S. Application Data
(60) Provisional application No. 63/347,630, filed on Jun. 1, 2022.

(51) Int. Cl. B01J 3/02; B01J 4/00; F16J 1/00

(52) U.S. Cl. CPC B01J 3/02; B01J 4/007; F16J 1/00; B01J 2204/002

(57) ABSTRACT

A piston having a chamber and a barrel disposed in and that may translocate within the chamber. The barrel includes a terminal end having a seal, and the seal has an annular ring having a first wall and a second wall, the second wall is orthogonal to and extends from the first wall such that a first portion of the first wall protrudes away from the second wall in a first direction and a second portion of the first wall protrudes away from the second wall in a second direction that is substantially opposite to the first direction.

The present disclosure generally relates to systems and methods for feeding a solid feedstock into a pressurized system. More specifically, the present disclosure relates to a solid feedstock feeder system having a piston feeder and seal.

### BACKGROUND OF THE DISCLOSURE

Currently, solid feedstock (e.g., solid biomass, municipal solid waste (MSW), coal, or any other suitable solid feedstock) is feed into a pressurized reactor by pressurizing a volume of the solid feedstock in, for example, a lock hopper system. While this approach is suitable for introducing the solid feedstock into the reactor, it requires a large vessel and consumes an undesirable amount of pressurized gas. In addition, existing lock hopper systems have a complex design. For example, the lock hopper system includes an atmospheric vessel, a sluice vessel, and a pressurized vessel along with several sets of valves. Moreover, because lock hopper systems pressurize the volume of the solid feedstock, a source of pressurized gas is required. It would be advantageous to use a solid feedstock feeding system that does not require the use of large amounts of pressurized gas and has a simpler design compared to existing lock hopper systems.

### SUMMARY

In an embodiment, a piston includes a chamber and a barrel disposed in and that may translocate within the chamber. The barrel includes a terminal end having a seal, and the seal has an annular ring having a first wall and a second wall, the second wall is orthogonal to and extends from the first wall such that a first portion of the first wall protrudes away from the second wall in a first direction and a second portion of the first wall protrudes away from the second wall in a second direction that is substantially opposite to the first direction.

In another embodiment, a solid feedstock feeding system includes a piston feeder that may receive a solid feedstock and includes an inlet, an outlet, and at least one piston disposed between the inlet and the outlet. The at least one piston includes a chamber and a barrel disposed in and that may translocate within the chamber, the barrel includes a terminal end having a seal, and the seal has an annular ring having a first wall and a second wall, the second wall is orthogonal to and extends from the first wall such that a first portion of the first wall protrudes away from the second wall in a first direction and a second portion of the first wall protrudes away from the second wall in a second direction that is substantially opposite from the first direction.

In a further embodiment, a system includes a solid feedstock feeding system having a piston feeder that may receive a solid feedstock and including an inlet, an outlet, at least one piston disposed between the inlet and the outlet. The at least one piston includes a first chamber and a barrel disposed in and that may translocate within the first chamber, the barrel includes a terminal end having a seal, and the seal includes an annular ring having a first wall and a second wall positioned orthogonal to and extending from the first wall such that a first portion of the first wall protrudes away from the second wall in a first direction and a second portion of the first wall protrudes away from the second wall in a second direction that is substantially opposite from the first direction. The system also includes a reactor disposed downstream from and fluidly coupled to the solid feedstock feeding system. The reactor includes one or more inlets that may receive the solid feedstock and to generate a product stream.

Additional features and advantages of exemplary implementations of the disclosure will be set forth in the description which follows, and in part will be obvious from the description, or may be learned by the practice of such exemplary implementations. The features and advantages of such implementations may be realized and obtained by means of the instruments and combinations particularly pointed out in the appended claims. These and other features will become more fully apparent from the following description and appended claims, or may be learned by the practice of such exemplary implementations as set forth hereinafter.

### BRIEF DESCRIPTION OF THE DRAWINGS

Advantages of the disclosure may become apparent upon reading the following detailed description and upon reference to the drawings in which:

FIG. 1 is a block diagram of a system that includes a pressurized reactor and a solid feedstock feeding system fluidly coupled to the pressurized reactor and having a piston feeder and a dosing tank, in accordance with an embodiment of the present disclosure;

FIG. 2 is a diagram of the solid feedstock feeding system of FIG. 1, whereby the piston feeder includes various pistons, in accordance with an embodiment of the present disclosure;

FIG. 3 is a diagram of a piston feeder that may be used in the solid feedstock system of FIG. 2, whereby the piston feeder includes a piston in a slanted configuration, in accordance with an embodiment of the present disclosure;

FIG. 4 is a perspective view of the components that make up a terminal end of a piston associated with the piston feeder of FIGS. 2 and 3, in accordance with an embodiment of the present disclosure;

FIG. 5 is a perspective view of the components of the terminal end of a piston associated with the piston feeder of FIGS. 2 and 3, in accordance with an embodiment of the present disclosure;

FIG. 6 is a perspective view of a terminal end of a piston associated with the piston feeder of FIGS. 2 and 3, in accordance with an embodiment of the present disclosure;

FIG. 7 is a cross-sectional view of the terminal end of the piston in FIG. 6 along line 7-7, in accordance with an embodiment of the present disclosure;

FIG. 8 is an exploded cross-sectional view of a portion of the terminal end of the piston in FIG. 7, in accordance with an embodiment of the present disclosure;

FIG. 9 is a cross-sectional view of the terminal end of a piston within a chamber of the piston feeder of FIGS. 2 and 3, in accordance with an embodiment of the present disclosure;

FIG. 10 is a cross-sectional view of the terminal end of the piston within a chamber of the piston feeder of FIGS. 2 and 3, whereby the terminal end includes a spring, in accordance with an embodiment of the present disclosure;

FIG. 11 is a cross-sectional view of the terminal end of the piston within a chamber of the piston feeder of FIGS. 2 and 3, whereby the terminal end includes a pressure assisted seat, in accordance with an embodiment of the present disclosure;

FIG. 12 is a cross-sectional view of the dosing tank of the solid feedstock feeding system of FIG. 2, whereby the dosing tank includes agitators and solid transport devices to move the solid feedstock, in accordance with an embodiment of the present disclosure;

FIG. 13 is flow diagram of a method for using the piston feeder of FIGS. 2 and 3 to provide a solid feedstock to the dosing tank, in accordance with an embodiment of the present disclosure;

FIG. 14 is a cross-sectional view of the piston feeder of FIG. 2, whereby a first chamber and a second chamber are in fluid communication and isolated from an outlet of the piston feeder, in accordance with an embodiment of the present disclosure;

FIG. 15 is a cross-section view of the piston feeder of FIG. 2, whereby the solid feedstock has been fed to the second chamber and the outlet is isolated from the second chamber, in accordance with an embodiment of the present disclosure;

FIG. 16 is a cross-sectional view of the piston feeder of FIG. 2, whereby the second chamber having the solid feedstock is isolated from a first chamber and the outlet, in accordance with an embodiment of the present disclosure;

FIG. 17 is a cross-sectional view of the piston feeder of FIG. 2, whereby the second chamber having the solid feedstock is in fluid communication with the outlet and isolated from the first chamber, in accordance with an embodiment of the present disclosure; and

FIG. 18 is a cross-sectional view of the piston feeder of FIG. 2, whereby a feed chamber is aligned with an inlet, and the second chamber and the outlet are isolated from the first chamber and the feed chamber, in accordance with an embodiment of the present disclosure; and

FIG. 19 is plot of the number of cycles as a function of leak flow for the piston feeder, in accordance with an embodiment of the present disclosure.

### DETAILED DESCRIPTION

One or more specific embodiments of the present disclosure will be described below. These described embodiments are examples of the presently disclosed techniques. Additionally, in an effort to provide a concise description of these embodiments, not all features of an actual implementation may be described in the specification. It should be appreciated that in the development of any such actual implementation, as in any engineering or design project, numerous implementation-specific decisions will be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features.

The terms “approximately,” “about,” and “substantially” as used herein represent an amount close to the stated amount that still performs a desired function or achieves a desired result. For example, the terms “approximately,” “about,” and “substantially” may refer to an amount that is within less than 10% of, within less than 5% of, within less than 1% of, within less than 0.1% of, and within less than 0.01% of a stated amount.

As discussed in further detail below, the disclosed embodiments include a piston feeder system that may be used to provide solid feedstock (e.g., biomass) to a pressurized reactor. Certain existing pressurized systems use a lock hopper to provide solid feedstock (e.g., biomass) to a pressurized reactor. Lock hoppers generally require the use of multiple vessels for storing, transferring, and discharging/blowing the solid feedstock into the pressurized reactor. One problem with existing lock hoppers is that, when the solid biomass falls into each vessel, the solid biomass is compacted. For example, certain lock hopper configurations have a storage tank that supplies the solid feedstock to a transfer vessel (e.g., sluice vessel) that is pressurized after having received the solid feedstock from the storage tank, which is at ambient pressure. As the solid feedstock falls from the storage tank into the transfer vessel, the solid feedstock may become compacted. Compacting of the solid feedstock in the transfer vessel results in lumps or clusters of solid feedstock, which impact the operation of the reactor and the efficiency as well as the reliability of the process that uses the pressurized reactor. For example, a lump or cluster of solid feedstock has substantially less surface area then the total surface area of the solid feedstock parts forming the lump or cluster; which may hinder the process efficiency. In addition, feedstock lumps or clusters will make the feeding operation unreliable due to bridging and blocking of the feed flow path by the lumps or clusters. Reactor operation is impacted as a result of the unstable and unreliable feeding as well as forming of solid tar lumps within the adjacent feeding system to the reactor (e.g., when using solid biomass to generate biofuels). Therefore, it is desirable to develop a solid feedstock feeding system that may provide industrial-scale volumes of solid feedstock to an industrial pressurized reactor in a manner that does result in compaction of the feedstock.

Moreover, the lock hopper feeding systems used in industrial-scale applications are based on batch-wise transportation of volumes of solid feedstock through the lock hopper vessels to the reactors, thereby the vessels used in the lock hopper feeding systems are generally large (e.g., typically holding volumes in the order of 50-80 cubic meters (m³)). As such, the amount of pressurized gas (e.g., approximately 5000 kilogram/hour (kg/hr)) used to transfer the required volume of the solid feedstock into the reactor may be undesirable. For example, the amount of pressurized gas required may impact the efficiency of the process due, in part, to the amount of energy used to pressurize the gas. Accordingly, it would be advantageous to develop a solid feedstock feeding system that does not require or uses a small amount of pressurized gas, and has a smaller/compact configuration that mitigates compaction of the solid feedstock compared to existing lock hopper feeding systems. It has been recognized that a piston feeder may be used to feed solid feedstock into a pressurized reactor at an industrial scale while mitigating the undesirable compacting, vessel size, and pressurized gas quantity associated with lock hopper feeding systems. Piston feeders generally use o-rings to seal and maintain pressure within its chambers (i.e. cylinders). However, over time, forces exerted on the o-rings from the reciprocating motion of the piston may result in creep and eventually damage to the o-ring such that the seal and the desired pressure within a respective chamber of the piston feeder is not maintained. Therefore, it may be advantageous to provide a piston feeder and seal that mitigate the problems associated with existing feedstock feeding systems. Disclosed herein is a piston feeder system having an improved seal for delivering a solid feedstock to an industrial reactor in a manner that maintains a desired pressure in respective chambers and does not rely on pressurized gas nor results in compaction of the solid feedstock.

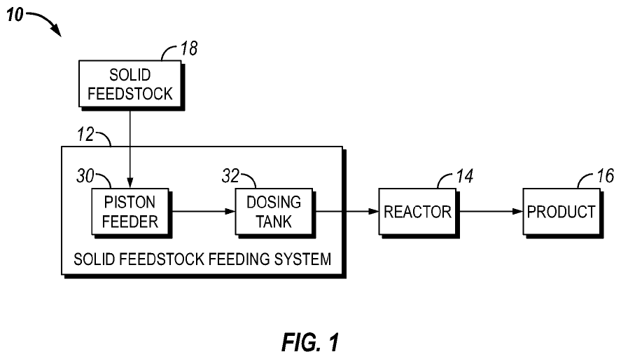

With the foregoing in mind, FIG. 1 is a block diagram of an embodiment of a system 10 that may include the disclosed piston feeder for providing a solid feedstock (e.g., biomass and/or waste plastics/oils) to a reactor (e.g., a pressurized reactor). In the illustrated embodiment, the system 10 includes a solid feedstock feeding system 12 and a reactor 14 positioned downstream from and fluidly coupled to the solid feedstock feeding system 12. The reactor 14 may be used to react a solid feedstock 18 with other components under pressure to generate a desired product 16 (e.g., a biofuel). For example, in operation, the pressure within the reactor 14 may be between approximately 0.1 megapascal (MPa) to approximately 5 MPa (approximately 1-50 bar). However, in other embodiments, the reactor 14 may be at a pressure greater than 5 MPa (50 bar). The reactor 14 may be any suitable reactor. By way of non-limiting example, the reactor 14 may be a fluidized bed reactor, fixed bed reactor, bubbling bed reactor, entrained flow reactor, or any other suitable reactor. In certain embodiments, the reactor 14 includes a catalyst. In other embodiments, the reactor 14 does not include a catalyst. While the illustrated embodiment has single reactor 14, it should be appreciated that the system 10 may include additional reactors and other system components that facilitate generating the desired product 16 without departing from the scope of the present disclosure. For example, the system 10 may include 1, 2, 3, 4, 5, 6, or more reactors 14 arranged in series or in parallel. Additionally, the system 10 may include particulate removal systems (e.g., cyclones, filters, or any other suitable separator for solids removal), purifying systems (e.g., distillation units, scrubbers, and the like) disposed downstream and fluidly coupled to the reactor(s) 14.

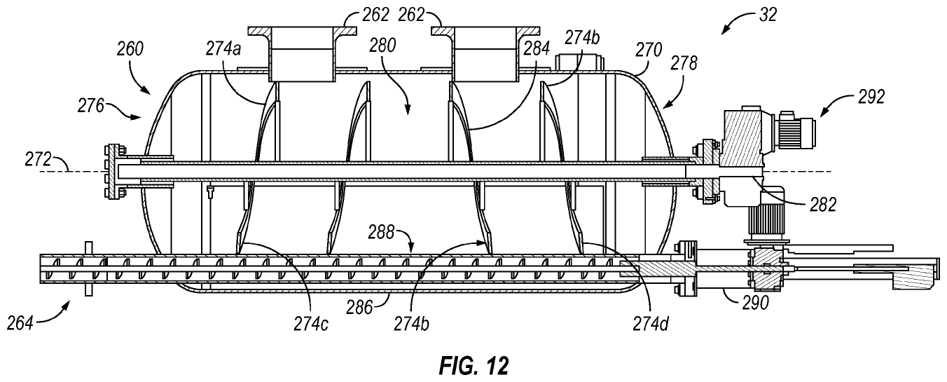

In operation, the solid feedstock 18 is introduced into the reactor 14 via a piston feeder 30 of the solid feedstock feeding system 12. As described in further detail below, the piston feeder 30 does not require the use of a pressurized gas and various vessels as in existing lock hopper feeding systems. Moreover, the piston feeder 30 has chambers for receiving and transferring the solid feedstock 18 that are approximately 75% or more smaller compared to the vessels used in existing lock hopper feeding systems. For example, the piston feeder 30 may have chambers that have a volume that is between approximately 75% and 99% less than a volume of the vessels in existing lock hopper systems. The solid feedstock feeding system 12 also includes a dosing tank 32 downstream from and fluidly coupled to the piston feeder 30 and the reactor 14. The configuration of the piston feeder 30 and the dosing tank 32 mitigate compacting of the solid feedstock 18 in the solid feedstock feeding system 12. In embodiments, in which the system 10 includes multiple reactors 14, the dosing tank 32 is fluidly coupled to and provides the solid feedstock 18 to each of the reactors 14, as discussed in further detail below with reference to FIG. 12. In one embodiment, the dosing tank 32 is positioned upstream of the piston feeder. In other embodiments, the system 10 does not include the dosing tank 32. As such, the piston feeder 30 feeds the solid feedstock 18 directing into the reactor 14 rather than into the dosing tank 32.

The solid feedstock 18 used in the disclosed process may include a residual waste feedstock and/or a biomass feedstock containing lignin, lignocellulosic, cellulosic, hemicellulosic material, or any combination thereof. Suitable lignocellulose-containing biomass includes woody biomass and agricultural and forestry products and residues (whole harvest energy crops, round wood, forest slash, bamboo, sawdust, bagasse, sugarcane tops and trash, cotton stalks, corn stover, corn cobs, castor stalks, Jatropha whole harvest, Jatropha trimmings, de-oiled cakes of palm, castor and Jatropha, coconut shells, residues derived from edible nut, rice husk, rice straw production and mixtures thereof), animal waste and municipal solid wastes containing lignocellulosic material. The municipal solid waste (MSW) may include any combination of lignocellulosic material (yard trimmings, pressure-treated wood such as fence posts, plywood), discarded paper and cardboard and waste plastics, along with refractories such as glass, metal. Prior to use in the process disclosed herein, municipal solid waste may be optionally converted into pellet or briquette form. The pellets or briquettes are commonly referred to as Refuse Derived Fuel in the industry. Certain feedstocks (such as algae and lemna) may also contain protein and lipids in addition to lignocellulose. Residual waste feedstocks are those having mainly waste plastics. In certain embodiments, the solid feedstock 19 may be different ranks of coal, peat or any other suitable solid feedstock that may be fed to a pressurized reactor.

The solid feedstock 18 may be provided to the reactor 14 in the form of loose particles having a majority of particles preferably less than about 3.5 millimeters (mm) in size or in the form of a solid/liquid slurry. However, as appreciated by those skilled in the art, the solid feedstock 18 may be pre-treated or otherwise processed in a manner such that larger particle sizes may be accommodated. In an embodiment of the present disclosure, a double-screw system having a slow screw for metering the solid feedstock 18 followed by a fast screw to push the solid feedstock 18 into the reactor without causing thermo-chemical reaction in the screw housing is used for dosing. An inert gas or hydrogen flow is maintained over the fast screw to further reduce the residence time of the solid feedstock 18 in the fast screw housing. As should be appreciated, dosing of the solid feedstock 18 into the reactor 14 may be achieved by other suitable means such as, but not limited to, a rotary valve.

### Solid Feedstock System

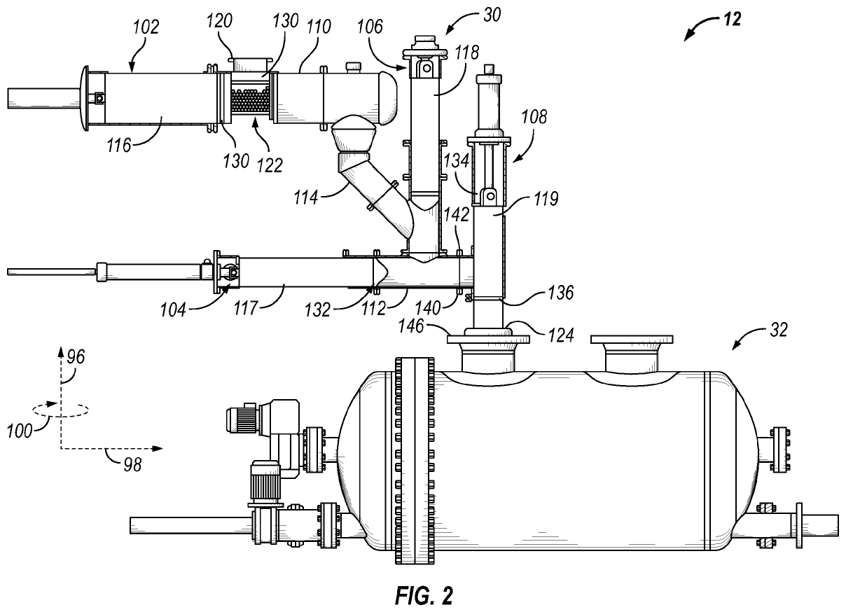

As discussed above, the solid feedstock system 12 provides the solid feedstock 18 to the reactor 14 in a manner that does not require a pressurized gas and large volume vessels compared to lock hopper feeding systems, and does not result in compaction of the solid feedstock 18. FIG. 2 illustrates an arrangement of the piston feeder 30 and the dosing tank 32 of the solid feedstock system 12, in accordance with an embodiment of the present disclosure. The solid feedstock system 12 may have an axial axis or direction 96, a radial axis or direction 98 away from axis 96, and a circumferential axis or direction 100 around the axis 96. The piston feeder 30 includes multiple pistons arranged in a manner that allow the solid feedstock 18 to move through the piston feeder 30 and into the dosing tank 32 while maintaining a desired pressure within each chamber of the piston feeder 30. For example, in the illustrated embodiment, the piston feeder 30 includes a first piston 102, a second piston 104, a third piston 106, and a fourth piston 108. The piston feeder 30 also includes a first chamber 110, a second chamber 112, and a conduit 114 extending between and fluidly coupling the chambers 110, 112. Each piston 102, 104, 106, 108 includes a respective barrel 116, 117, 118, and 119. The barrel 116, 117, 118, 119 translocates within a respective chamber to facilitated movement of the solid feedstock 18 through the piston feeder 30 and into the dosing tank 32, as discussed in further detail below.

In addition, the piston feeder 30 includes an inlet 120 positioned adjacent to and extending in the axial direction 96 away from the first piston 102 and the first chamber 110, a feed chamber 122 disposed within the first chamber 110 and fluidly coupled to the inlet 120, and an outlet 124 positioned adjacent to and extending axially 96 away from the fourth piston 108 and the second chamber 112. However, the inlet 120 and the outlet 124 may be arranged in any other suitable manner than allows a flow of the solid feedstock 18 into and out of the piston feeder 30.

At least a portion of the barrel 116 of the first piston 102 is disposed within the first chamber 110 and moves (e.g., translocates) along a length of the first chamber 110, for example, in the radial direction 98 to move the solid feedstock 18 from the first chamber 110 and into the conduit 114. Similar to the first piston 102, at least a portion of the barrel 117 of the second piston 104 is disposed within the second chamber 112 and moves (e.g., translocates) along a length of the second chamber 112 to move the solid feedstock 18 from the second chamber 112 and into the dosing tank 32. In the illustrated embodiment, a portion of the conduit 114 is slanted relative to the axial axis 96. However, in certain embodiment, the conduit 114 may be parallel to the axial axis 96.

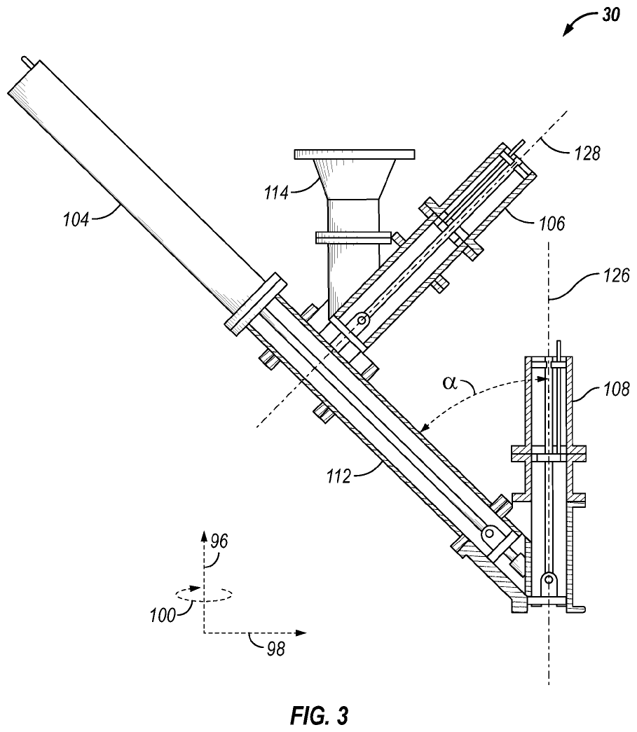

In the illustrated embodiment, the first piston 102 and the second piston 104 radially extend along the radial axis 98 and are positioned parallel to one another. The third piston 106 and the fourth piston 108 extend axially along the axial axis 96 and are parallel to one another and orthogonal to the pistons 102, 104. However, in other embodiments, the pistons 102, 104 are not positioned parallel to one another. For example, FIG. 3 illustrates an embodiment of the piston feeder 30 in which the piston 104 is oriented at an acute angle a relative to a centerline axis 126 of the piston 108 and orthogonal to a centerline axis 128 of the piston 106. Consequently, the second chamber 112 of the piston feeder 30 is also oriented at the acute angle a relative to the centerline axis 126 of the piston 108. By arranging the piston 104 and the second chamber 112 in this way, the solid feedstock may move along the second chamber 112 easily due, in part, to gravitational forces and eroding of an interior surface of the second chamber 112 may be mitigated. For example, the solid feedstock may be abrasive and scratch, or otherwise erode, the interior surface of the second chamber 112 as the barrel 117 of the piston 104 pushes the solid feedstock toward the fourth piston 108 and into the dosing tank 32. Such movement of the solid feedstock may, overtime, wear away the interior surface of the second chamber 112. In addition, the solid feedstock may lodge between the interior surface of the second chamber 112 and the outer surface of the barrel 117. As such, the barrel 117 may be unable to properly move within the second chamber 112 and transfer the solid feedstock into the dosing tank 32. The slanted, or angled, configuration of the second piston 104 and the second chamber 112 may mitigate wear of the piston feeder surfaces (e.g., the interior surface of the second chamber 112 and the outer surface of the piston 106) and lodging of the solid feedstock between the interior surface of the second chamber 112 and the outer surface of the piston 104.

Returning to FIG. 2, the outlet 124 couples (e.g., connects) the piston feeder 30 to the dosing tank 32 such that the solid feedstock 18 may be transferred from the second chamber 112 to the dosing tank 32. In operation, the first chamber 110 and the conduit 114 are maintained at ambient pressure (e.g., approximately 0.1 MPa (1 bara)) and the second chamber 112 and the dosing tank 32 are pressurized according to the pressure within the reactor 14. For example, the second chamber 112 and the dosing tank 32 may be at a pressure of between approximately 0.1 megapascal (MPa) to approximately 5 MPa (approximately 1-50 bara). As discussed in further detail below, the third piston 106 may be used to maintain the different pressures within the chambers 110, 112 and mitigate flow back of the solid feedstock 18 from the dosing tank 32 back into the piston feeder 30 due to pressure differentials between, for example, a feedstock storage tank and the dosing tank 32

The piston feeder 30 includes various valves and seals that facilitate a flow of the solid feedstock 18 through the chambers 110, 112 and the conduit 114, and mitigate flow back of the solid feedstock 18 from the dosing tanks 32 and/or reactor 14 back into the piston feeder 30. For example, the piston feeder 30 includes a seal 130 and 132 at an end of the barrels 116, 117, respectively. The piston feeder 30 also includes pressure seals 134 and 136 at an end of the barrels 118. 119, respectively. In operation, the pressure seal 136 provides a seal between the dosing tank 32 and the second chamber 112 such that when the second chamber 112 receives the solid feedstock 18 from the first chamber 110, which is at atmospheric pressure (e.g., 0.1 MPa (1 bara)), the solid feedstock 18 in the dosing tank 32, which is at a higher pressure than the chamber 110, 112 (e.g., at a pressure of between 0.6 MPa (6 bara) and 5 MPa (50 bara)), does not flow back into the piston feeder 30. Similarly, the pressure seal 134 provides a seal between the chambers 110, 112 such that when the second chamber 112 is pressurized to equal the pressure within the dosing tank 32, the solid feedstock 18 does not flow back into the first chamber 110 and the conduit 114, which are at atmospheric pressure. Once the second chamber 112 is isolated from the first chamber 110, conduit 114, and dosing tank 32, the second chamber 112 may be filled with H₂ and pressurized to the pressure within the dosing tank 32 and the reactor 14. For example, the piston feeder 30 may have a purge valve 140 and a bypass valve 142 that allow the second chamber 112 to be filled with the H₂ and pressurized the chamber 112. During pressurization of the second chamber 112, the valves 140, 142 are open to allow the air within the chamber 112 to be displaced by the H2. After some time, the purge valve 140 is closed and the bypass valve 142 remains open such that the chamber 112, that is filled with H₂, may be pressurized to the desired pressure. Once the second chamber 112 is at the desired pressure, the bypass valve 140 is closed and the third piston 108 moves in the axial direction 96 away from the outlet 24 to release the seal and allow fluid communication between the second chamber 112 and the outlet 124.

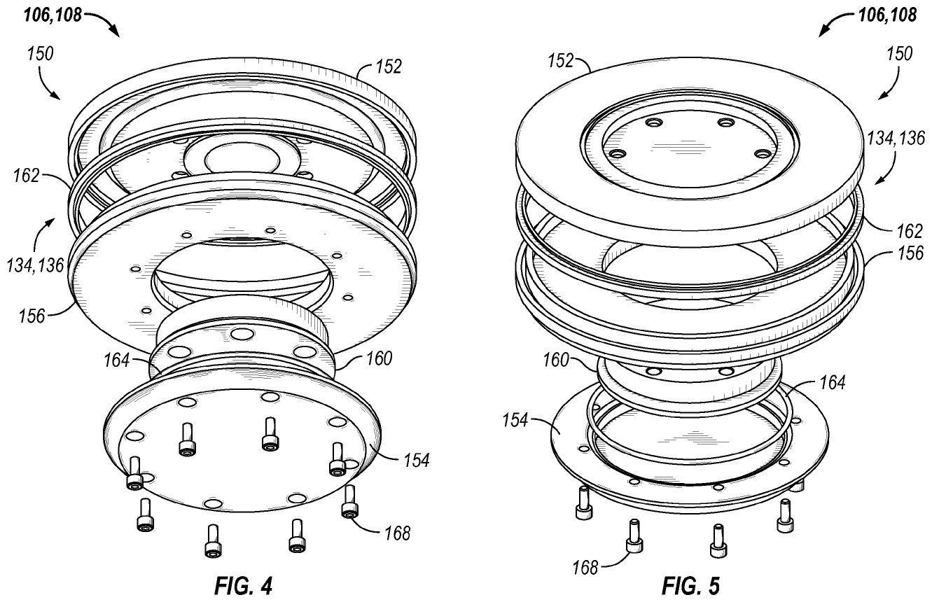

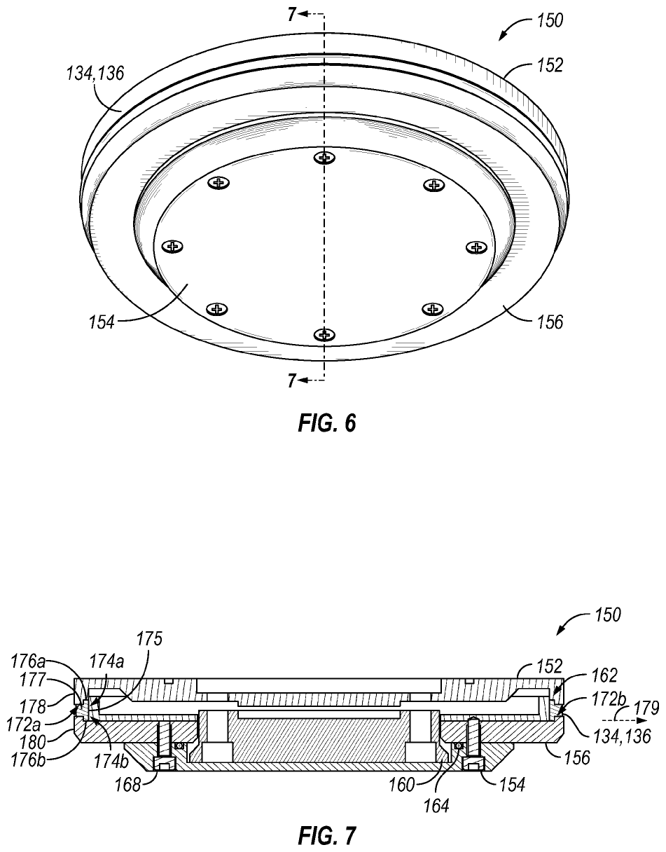

As discussed above, certain existing piston feeders use an o-ring to provide a seal and maintain pressure in a respective chamber. However, the force exerted on the o-ring by the continuous motion of the piston results in creep of the o-ring and, over time, damage. As such, the o-ring may be unable to seal and maintain the desired pressure within the respective chamber. Therefore, the pressure seal 134, 136 disclosed herein is configured in a such a way to mitigate damage resulting from the forces exerted by the piston 106, 108. For example, FIGS. 4 and 5 are perspective views of an end portion 150 of the piston 106, 108 having the disclosed pressure seal 134. 136. In addition to the pressure seal 134, 136, the end portion 150 includes a top plate 152, a bottom plate 154, a middle plate 156, and an insert 160. The pressure seal 134, 136 has an annular ring 162 that is positioned between the plates 152, 156. The end portion also includes an o-ring 164 between the bottom plate 154 and the insert 160. The plates 152, 154, 156, the insert 160, the pressure seal 134, 136, and the o-ring 164 are held together by bolts 168, thereby forming the end portion 150, as shown in FIG. 6.

FIG. 7 is a cross-sectional view of the end portion 150 along line 7-7. As shown in the illustrated embodiment, the annular ring 162 of the pressure seal 134, 136 has recesses 172 and protrusions 174 such that the annular ring 162 has a T-shaped cross-section. For example, the annular ring 162 has a first wall 175 extending between a first side 176a and a second side 176b of the annular ring 162, the second side 176b being substantially opposite (e.g., 180 degrees) from the first side 176a. The annular ring 162 also has a second wall 177 extending from and orthogonal to the first wall 175. The second wall 177 forms part of the first side 176a and the second side 176b. A portion of the first wall 175 extends (or protrudes out) from a surface of the first side 176a to form the protrusion 174a and recess 172a, and another portion of the first wall 175 extends (or protrudes out) from a surface of the second side 176b to form the protrusion 174b and recess 172b, thereby giving the annular ring 162 the T-shaped cross-sectional geometry. In certain embodiments, a flat ring may be disposed between the protrusion 174a and an inner surface of the plate 152 such that the terminal end of the protrusion 174a is not against and abuts the inner surface of the plate 152. In the illustrated embodiment, the protrusions 174 have a rectangular or square geometry. However, the protrusions 174 may have any other suitable geometry such as trapezoidal, triangular, polygonal, and combinations thereof. For example, in certain embodiments, protrusion 174a may have one cross-sectional geometry and the other protrusion 174b may have another cross-sectional geometry that is different from the cross-sectional geometry of the protrusion 174a.

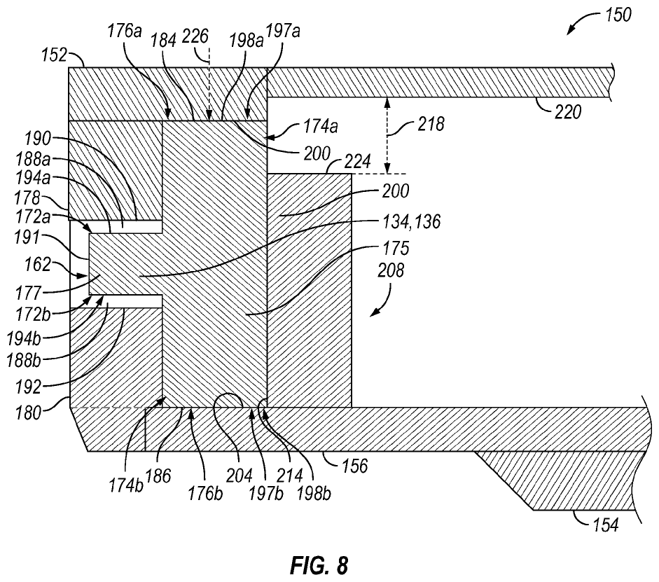

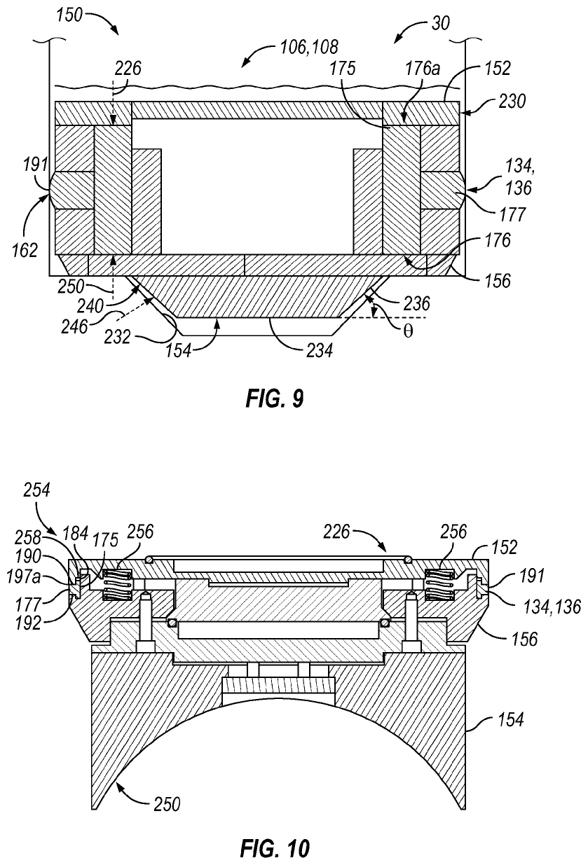

As discussed in further detail below, the T-shape of the annular ring 162 facilitates coupling of the pressure seal 134, 136 to the end portion 150 and mitigates damage that may be caused by the forces exerted on the seal 134, 136 by the plates 152, 154 during operation of the piston feeder 30. For example, during operation, the second wall 177 of the seal 134, 136 expands in a linear direction 179 toward an inner surface of a respective piston chamber housing the barrels of the piston 106, 108 (e.g., the barrels 118, 119), thereby creating the seal. In addition to creating the seal, the liner movement (i.e., expansion) of the second wall 177 cleans the sealing surface during movement of the piston 106, 108 by removing feedstock that may be lodged between the barrel of the piston 106, 108 and the inner surface of the piston chamber. When the seal 134, 136 is deactivated, the second wall 177 retracts and returns to its original shape. Unlike o-ring shaped seals, the first wall 175 (e.g., the T-bar) forces the second wall 177 back to its original shape as the first wall 175 is held in place by the plates 152, 156 and is unable to move. As such, the first wall 175 pulls the second wall 177 back to its original shape and mitigates wear on the seal 134, 136 that may be caused by frictional forces exerted by the inner surface of the piston chamber onto the second wall 177. The T-shape of the annular ring 162 blocks, or otherwise mitigates, the pressure seal 134, 136 from creeping and allows it to maintain its original diameter. Additionally, narrow tolerances of the T-shape mitigate extrusion of portions of the seal 134, 136 as it is compressed during operation, which would change its shape and available material resulting in loss of sealing effectiveness. The annular ring 162 may be formed from an elastic incompressible material such that the annular ring may expand and contract to return to its original shape after application and removal of forces exerted by the plates 152. 154. 156. By way of non-limiting example, the thermoplastic material may be selected from polyurethane materials and the like. As used herein, the term “elastic incompressible material” denotes a material that maintains its density (i.e., it is incompressible) but not necessarily its shape (i.e., the material deforms) when a force is applied, and returns to its original shape when the force is removed. To facilitate discussion of the pressure seal 134, 136, reference will be made to FIG. 8, which is an exploded view of a section of the end portion 150. As shown in the illustrated embodiment, the T-shape cross-sectional geometry of the annular ring 162 facilitates retaining the pressure seal 134, 136 in the end portion 150. For example, the plates 152, 156 each have a lip 178, 180, respectively, that form a rim around an outer circumference of the plates 152, 156. The plates 152, 156 also have a recessed wall 184, 186 (e.g., annular recesses wall) sized and shaped to receive the protrusions 174a, 174b, respectively, of the pressure seal 134, 136. When assembled, the pressure seal 134, 136 does not about a top plate outer surface 190 and a middle plate outer surface 192. For example, as shown in the illustrated embodiment, there is a gap 188a between a first seal outer surface 194a and the top place outer surface 190, and a gap 188b between a second seal outer surface 194b and the middle place outer surface 192. The gap 188 extends circumferentially around the end portion 150 when the seal is not activated. Additionally, a terminal end 191 of the second wall 177 is positioned entirely within the lips 178, 180 such that the terminal end 191 does not protrude away from or is flush with the outer surfaces of the end portion 150. That is, the terminal end 191 is nested within the plates 152, 156. This seal configuration keeps the seal 134, 136 from rubbing against an inner surface of the respective piston feeder chamber the piston during movement of the piston, thereby mitigating creep and damage to the seal during operation. Additionally, it allows for the second wall 177 to expand and create the seal when pressure is applied by the plates 152, 156 as described in further detail below with reference to FIG. 9. Unlike the surfaces 194 of the second wall 177, portion 198a, 198b of seal outer surface 197a, 197b of the sides 176a, 176b abuts a top plate surface 200 and middle plate surface 204, respectively. That is, there is no gap between the outer surface 197 of the pressure seal 134, 136 and the respective plate surfaces 220, 204. In addition, the middle plate 156 includes an interior wall 208 adjacent to the recessed wall 186 and extending from the middle plate surface 204. An outer portion 210 of the first wall 175 abuts an outer surface 214 of the interior wall 208.

A second gap 218 between a top plate inner surface 220 and a terminal end 224 of the interior wall 208 allows for the top plate 152 to exert a force 226 on the pressure seal 134, 136 when the piston (e.g., the piston 106, 108) translocates to isolate the chamber (e.g., the second chamber 112) and/or the outlet (e.g., the outlet 124) such that a pressure differential between the dosing tank (e.g., the dosing tank 32) and piston chambers at atmospheric pressure (e.g., the first chamber 110 does not result in flow back of the solid feedstock (e.g., the solid feedstock 18) from the dosing tank back into the piston feeder (e.g., the piston feeder 30). For example, as the piston 106, 108 moves in a direction towards the outlet 124 the bottom plate 154 abuts against a terminal end of the chamber it is in causing the bottom plate 154 and the middle plate 156 to move in a direction opposite to the direction the piston 106, 108 is moving. Consequently, the gap 218 is decreased causing the top plate 152 to exert the force 226 on the pressure seal 134, 136. The bottom plate 154 also exerts a force counter to the force 226, which pushes against the pressure seal 134, 136, thereby causing a portion of the annular ring 162 to compress and pushing it towards an inner wall of the chamber, as explained in further detail below. The compression of the annular ring 162 creates a seal within the chamber and blocks fluid communication between a space of the piston feeder or chamber adjacent to (or above) the top plate 152 and a space of the piston feeder or chamber adjacent to (or below) the bottom plate 154.

For example, FIG. 9 is cross-sectional view of a portion of the piston feeder 30 having the pressure seal 134, 136 of the present disclosure in an activated configuration. In the illustrated embodiment, the end portion 150 of the piston 106, 108 is positioned within a chamber 230 of the piston feeder 30 such that the bottom plate 154 abuts against a portion of an inner chamber wall 232. The bottom plate 154 has a beveled terminal end 234 having a slanted wall 236 that forms an angle θ of between approximately 30° and 50°. A portion 240 of the beveled terminal end 234 contacts the inner chamber wall 232 such that the inner chamber wall 232 exerts a force 246 against the bottom plate 152. Consequently, the gap 218 decreases, thereby exerting the force 226 and a counter force 250 onto the pressure seal 134, 136 causing the annular ring 162 compress and the second wall 177 to expand, thereby closing the gap 188 and pushing the terminal end 191 out toward an inner surface 252 of the chamber 230 to provide the seal. The T-shape configuration of the annular ring 162, in combination with the beveled terminal end 234 of the bottom plate 154, mitigate damage to the annular ring 162 that may be caused by creep, as discussed above.

FIG. 10 illustrates an alternative embodiment of the end portion 150 of the piston 106, 108 in which the end portion includes a spring and an o-ring between the plates 152, 154. For example, in the illustrated embodiment, an end portion 254 includes a spring 256 within a void 258 that forms between the plates 152, 156 of the end portion 254. Unlike the end portion 150, the end portion 254 does not include a separate middle plate (e.g., the middle plate 156). Rather, the bottom plate 154 of the end portion 254 is combined with the middle plate (e.g. the middle plate 156) such that the bottom plate 154 and the middle plate form a single unitary structure. In the illustrated embodiment, coupled to the bottom plate 154 is a volume dispenser 255 having a concave configuration. The volume dispenser 255 facilitates movement of the solid feedstock through the piston feeder, the dosing tank, and/or the reactor.

As discussed above, the seal 134, 136 expands when activated, forcing the second wall 177 toward the inner surface of the piston chamber (e.g., the inner surface 252) to create the seal. When the seal 134, 136 is deactivated (e.g., when the seal is broken), the second wall 177 is pulled toward the first wall 175 and the seal 134, 136 returns to its original shape. The spring 256 facilitates pulling the second wall 177 toward the first wall 175 after the forces 226, 250 are released by overcoming the friction forces exerted on the second wall 177 by the surface 190, 192 of the plates 152, 156, respectively. In addition to facilitating retraction of the second wall 177 when the seal 134, 136 is deactivated, the spring 256 mitigates wear of the terminal end 191 resulting from friction forces exerted by the inner surface of the piston chamber against the terminal end 191 when the second wall 177 does not retract to its original shape once deactivated. For example, once the seal 134, 136 is deactivated, the piston 106, 108 moves in a direction away from an end of the chamber (e.g., in a direction that is substantially the same as the counter force 250). If the second wall 177 of the seal 134, 136 does not retract to its original shape, the terminal end 191 may rub against the inner surface of the chamber. This rubbing (i.e., friction) may wear the seal 134, 136 over time causing leakage and feedstock to get trapped between the piston and the inner surface of the chamber. The spring 256 may be any spring suitable for overcoming the friction forces of the seal 134, 136. The spring 256 has an annular configuration and may be made from materials such as, but not limited to, steel, metal alloys, or the like. The end portion 254 may have any number of springs 256. For example, the end portion 254 may have 1, 2, 3, 4, 5, 6, 7, 8, 9, 10, or more springs 256.

In addition to the spring 256, the end portion 254 includes a backup ring 258 between the recessed wall 184 and the outer surface 197a of the pressure seal 134, 136. The backup ring 258 mitigates extrusion of the first wall 175, for example, when there is a gap between the recessed wall 258 and the outer surface 197a of the seal 134, 136. The backup ring 258 may be made of any suitable material with sufficient durability and elastomeric properties to withstand the forces 226, 250 and block extrusion of the first wall 175 during operation of the piston feeder. By way of non-limiting example, the backup ring 258 may be a nylon ring or the like.

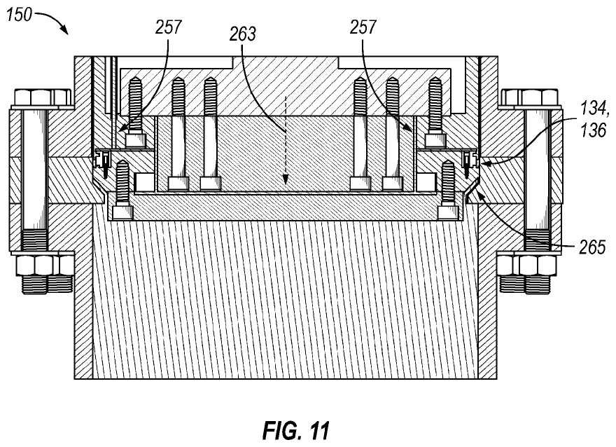

FIG. 11 illustrates another embodiment of the end portion 150 of the piston 106, 108 in which the end portion includes a pressure assisted seat 253. The pressure-assisted seat 253 works by balancing of process pressure 255 (e.g., the pressure below the end portion 150) against seat pressure 257 (e.g., the pressure inside of the piston for de-activating the seal function). The seat pressure 257 is maintained higher than the process pressure 255. For example, the seat pressure 257 is maintained at between approximately 0.5% and 25% higher than the process pressure 255. By way of non-limiting example, the seat pressure 257 may be between approximately 1 and 15 bar higher than the reactor pressure, and the process pressure 255 may be between approximately 1 and 10 bar higher than reactor pressure. In this way, it is ensured that the pressure on the seal 134, 136 may be released when the piston (e.g., the piston 106, 108) is retracted independently of the operating pressure. An advantageous aspect of this design is that having a higher seat pressure 257 compared to the process pressure 255 secures the retraction of the seal 134, 136 when removing pressure from the pressure-assisted seat 253 when the piston moves away from the outlet (e.g., the outlet 124) of the piston feeder or of the chamber in which the piston is housed. Additionally, bearings may be positioned adjacent to seal 134, 136 (e.g., adjacent to and abutting the first wall 175 of the T-shaped annular ring 162) to control the concentricity of the pressure-assisted seat 253. The bearings ensure that the seat can move axially without damaging surfaces of the end portion 150 and the piston chamber. The bearings 259 may be made from a material having a hardness that is different from a hardness of the pressure-assisted seat 253. By way of non-limiting example, the bearings may be bronze or any other material that is softer than the material of the pressure-assisted seat 253. A central part 263 sets the precompression of the seal 134, 136 when no pressure is set on a metal-metal seat 265. The central part 263 of the end portion 150 of the piston is pressurized by an external source of inert gas though a pipe in the piston. By maintaining a higher pressure in the piston than in the process it is ensured that all leaks will be from the inside and out and thereby avoiding dust or foreign matters from entering the moving parts of the seat construction. For example, the higher pressure in the metal-metal seat 265 compared to the process pressure ensures that dust does not accumulate and, in case there is a leak due to a damaged O-ring, gas will not flow into the equipment which may otherwise cause damage and impact performance.

As discussed above, the disclosed piston feeder (e.g., the piston feeder 30) provides solid feedstock (e.g., the solid feedstock 18) to the dosing tank 32. The dosing tank 32 may include additional features such as agitators and screw conveyors that keep the solid feedstock 18 in motion, mitigate compaction, and facilitate dosing the solid feedstock 18 into the reactor 14. FIG. 12 is a cross-sectional view of an embodiment of the dosing tank 32. The dosing tank 32 includes the body 260, inlets 262, and outlet 264. While in the illustrated embodiment, the dosing tank 32 has a single outlet 264, the dosing tank 32 may have multiple outlets. The body 260 defines a housing 270 (e.g., vessel) of the dosing tank 32 that contains a desired volume of feedstock (e.g., the solid feedstock 18). For example, the housing 270 may contain a volume of solid feedstock that is between approximately 10 m³ to 130 m³. As such, dimensions of the housing 270 may be between approximately 2 m (meters) diameter×4 m length and 4 m diameter×10 m length. However, as should be appreciated, the housing 270 may be any size suitable for containing the desired amount of solid feedstock. The housing 270 has a longitudinal axis 272 that extends from a first end 276 to a second end 278 of the dosing tank 32. In embodiments having multiple outlets 264, one or more outlets 264 are positioned at the first end 276 and one or more outlets 264 are positioned on the second end 278. The outlets 264 may feed the solid feedstock (e.g., the solid feedstock 18) into the reactor (e.g., the reactor 14) symmetrically (e.g., each outlet feeding the solid feedstock into the reactor simultaneously) or in series (e.g., one outlet feeds the solid feedstock into the reactor followed by the other outlet feeding the feedstock into the reactor). Each outlet 264 may dose the same or different amounts of the solid feedstock into the reactor. In certain embodiments, each outlet 264 may be fluidly coupled to separate reactors such that one dosing tank 32 may feed the solid feedstock into multiple reactors.

As shown in FIG. 12, along the longitudinal axis 272 are multiple agitators 274 that move the solid feedstock entering the housing 270 toward a center 280. The agitators 274 include a shaft 282 having a plurality of blades 284 that maintain movement of the solid feedstock 18 within the dosing tank 32. In operation, the agitators 274a and 274c move in a first direction along the longitudinal axis 272 such that the respective blades 284 move a first portion of the solid feedstock 18 toward the center 282, and the agitators 274b and 176d move in a second direction opposite the first direction along the longitudinal axis 272 such that the respective blades 284 move a second portion of the solid feedstock 18 toward the center 280.

The housing 270 also includes one or more troughs 286 into which the solid feedstock enters through an opening 288 at the center 280 of the housing 270. The troughs 286 extend along the longitudinal axis 272 from the first end 276 to the second end 278 and terminate at the respective outlet 264. In embodiments having multiple troughs 286, the troughs 286 are adjacent to one another and separated by a partition such that the solid feedstock in one trough 286 is separated from the solid feedstock in an adjacent trough 286. Each trough 286 includes a solid feed transport device 290 that moves and doses the solid feedstock in the trough 286 to the reactor (e.g., the reactor 14). By way of non-limiting example, the solid feed transport device 290 is a screw conveyor type, pneumatic transport system, or any other suitable solid feed transport device. The dosing tank 32 may include one or more control device 292 that control and facilitate movement of the agitator 274 and the solid feed transport device 290. The agitators 274 and the solid feed transport device 290 operate independently from one another. Therefore, the agitator 274 and the solid feedstock transport device 290 each have their own control device 292. However, in certain embodiment, the agitator 274 and the solid feedstock transport device 290 are independently operated using the same control device 292. As should be appreciated, the dosing tank 32 may be used in combination with the disclosed piston feeder. It may be positioned upstream or downstream of the piston feeder. In certain embodiments, the dosing tank 32 may be integral with the piston feeder. In other embodiments, the dosing tank 32 is a standalone unit that is separate from and removably coupled to the piston feeder. By having the dosing tank 32 as a standalone unit, it may be retrofit into existing reactor system and allows flexibility in adjusting the solid feedstock feeding system configuration (e.g., move the dosing tank from a downstream position to an upstream position relative to the piston feeder, remove the dosing tank from a solid feedstock feeding system already in place, or add the dosing tank to a solid feedstock feeding system already in place).

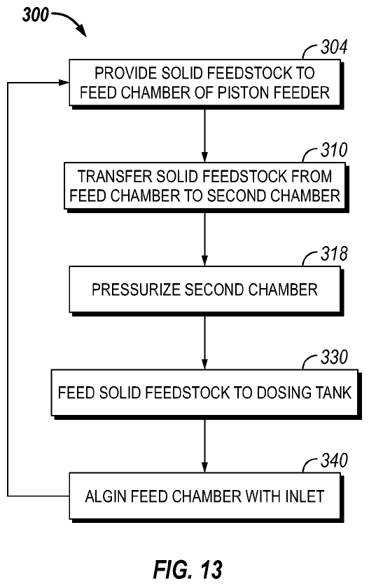

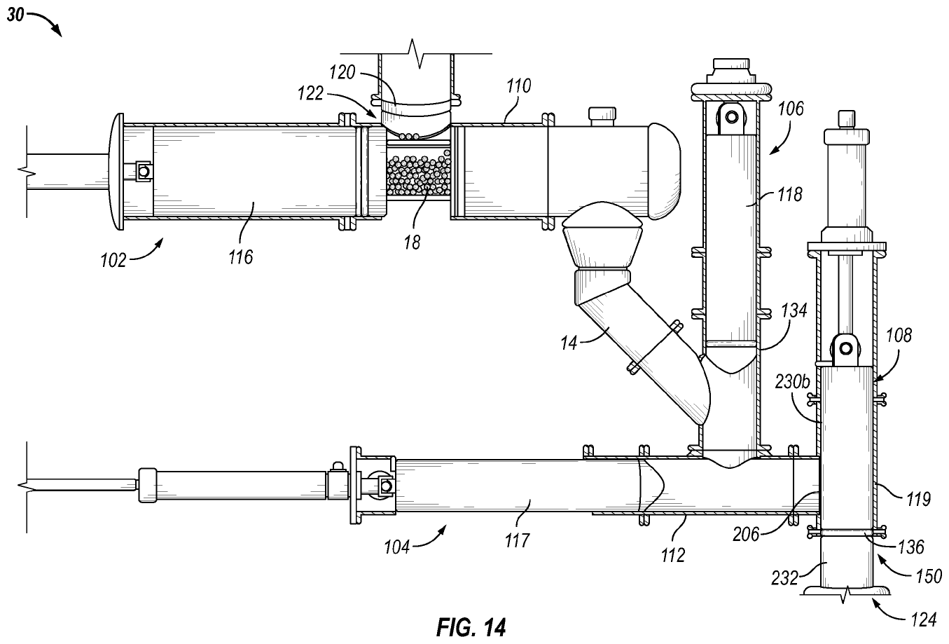

Present embodiments also include a method of feeding a solid feedstock (e.g., the solid feedstock 18) to a reactor (e.g., the reactor 14). For example, FIG. 13 is a flow diagram of a method 300 that may be used to feed the solid feedstock into the reactor using the disclosed piston feeder (e.g., the piston feeder 30), while also avoiding flow back of the solid feedstock from the dosing tank (e.g., the dosing tank 32) back into the piston feeder. To facilitate discussion of the acts of the method 300, reference will be made to FIG. 14-18. The method 300 includes providing the solid feedstock to a first chamber of the piston feeder at ambient pressure (block 304).

For example, with reference to FIG. 14, the piston feeder 30 receives the solid feedstock 18 from a solid feedstock storage tank through the inlet 120. As shown in the illustrated embodiment, the inlet 120 is fluidly coupled to the feed chamber 122. The feed chamber 122 is aligned with the inlet 120 and receives the solid feedstock 18 from the solid feedstock storage tank disposed upstream of the piston feeder 30. In the illustrated embodiment, the fourth piston 108 is positioned such that the chambers 110, 112, 122 and the conduit 114 are isolated from the outlet 124 and the dosing tank (e.g., the dosing tank 32) to avoid flow back of the solid feedstock 18 that may be in the dosing tank. For example, as discussed above the dosing tank is at a pressure of between approximately 0.6 MPa (6 bara) and 5 MPa (50 bara), which is the pressure within the reactor (e.g., the reactor 14). In contrast, the pressure within the chambers 110, 112, 122 and the conduit 114 is at ambient (e.g., approximately 0.1 MPa (1 bara)). The pressure differential between the piston feeder 30 and the dosing tank may cause flow black of the solid feedstock 18 back into the piston feeder 30 if an exit 206 of the second chamber 112 is not blocked and isolated from the outlet 124. Therefore, while in this position, the end portion 150 of the fourth piston 108 abuts the inner chamber wall 232 of the chamber 230b, thereby exerting a force on the pressure seal 136 causing it to compress, which forces it out against an inner surface of the chamber 230b. In this way, the pressure seal 136 provides a seal and isolates the outlet 124 from the chambers 110, 112, 122 and the conduit 114 to maintain the pressuring at the outlet 124 substantially the same as the pressure within the dosing tank.

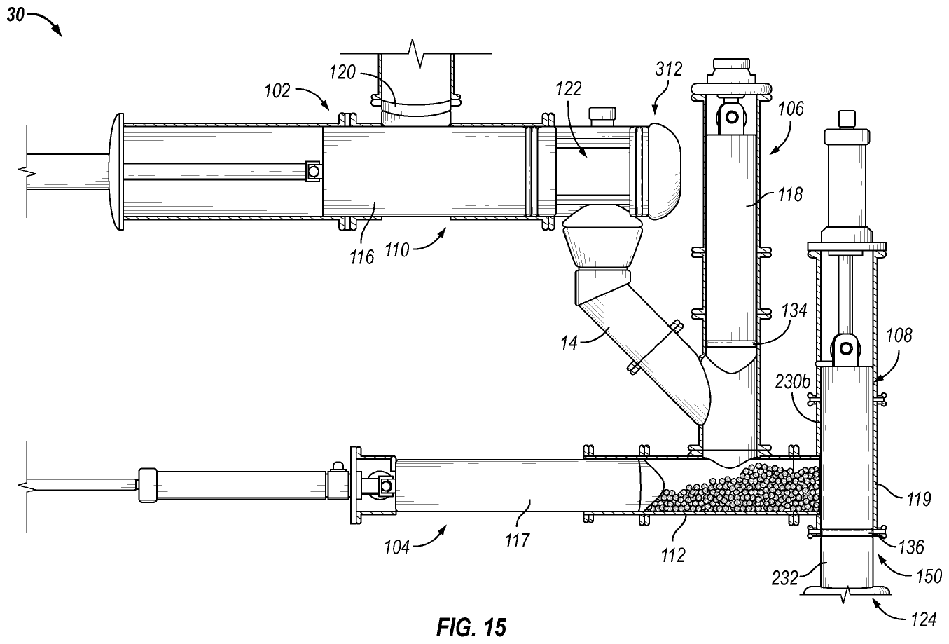

Returning to FIG. 13, the method 300 also includes transferring the solid feedstock from the feed chamber into the second chamber (block 310). For example, as shown in FIG. 15 the first piston 102 moves towards a terminus 312 of the first chamber 110 to align the feed chamber 122 with an opening 316 of the conduit 114. Once the feed chamber 122 is aligned with the opening 316, the solid feedstock 18 flows through the conduit 114 and into the second chamber 112. The fourth piston 108 remains in place to continue isolating the outlet 124 and blocking fluid communication between the chambers 110, 112, 122 and the conduit 114 and the dosing tank, thereby mitigating flow back of the solid feedstock 18 already in the dosing tank.

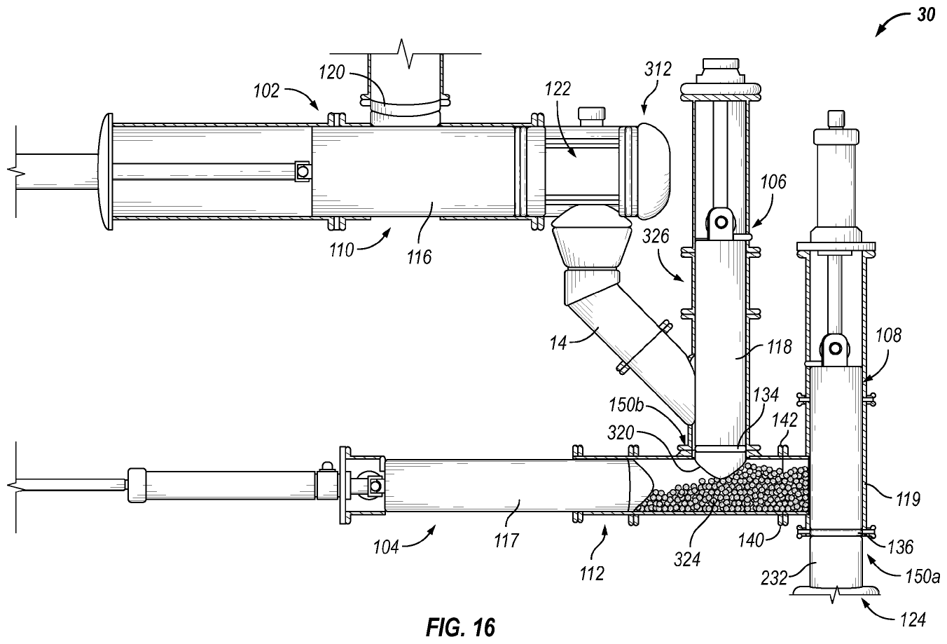

Once again returning to FIG. 13, following transfer of the solid feedstock to the second chamber in accordance with the acts of block 310, the method 300 includes pressurizing the second chamber (block 318). For example, the third piston 106 moves toward the second chamber 112, thereby blocking fluid communication between the chambers 110, 122 and the conduit 114 and the second chamber 112, as shown in FIG. 16. The second chamber 112 is isolated from the conduit 114 (and anything upstream of the conduit 114) and the outlet 124 of the piston feeder 30. Similar to the fourth piston 108, the end portion 150b of the third piston 106 abuts an inner wall 320 of a chamber inlet 324 associated with the second chamber 112, thereby exerting a force on the pressure seal 134 causing it to compress, which forces it out against an inner surface of a second conduit 326 that houses the barrel 118 of the third piston 106. The fourth piston 108 remains in position blocking fluid communication between the second chamber 112 and the outlet 124. In this way, the pressure seal 134 provides a seal and isolates the second chamber 112 from the conduit 114 and upstream of the conduit 114, and the pressure seal 136 seals and isolates the second chamber 112 from the outlet 124 to allow the second chamber 112 to be pressurized to a pressure that is substantially the same as the pressure within the dosing tank.

For example, a pressure of the second chamber 112 is at ambient. Therefore, the second chamber 112 is pressurized according to block 312 of the method 300 such that the pressure within the second chamber 112 is approximately equal to the pressure within the dosing tank. Pressurizing the second chamber 112 before feeding the solid feedstock 18 into the dosing tank mitigates flow back of the solid feedstock 18 within the dosing tank that may be caused due to the pressure differential between the second chamber 112 and the dosing tank. As discussed above, the second chamber 112 includes the bypass valve 140 through which H₂ gas may be injected into the second chamber 112. The purge valve 142 is opened such that the air within the second chamber 112 may be displaced by the H₂ gas. Once the air within the second chamber 112 is displaced, the purge valve 142 is closed and the H₂ gas continues to fill the second chamber 112 until the desired pressure is reached. For example, the dosing tank may be at a pressure of between approximately 0.6 MPa (6 bara) and 5 MPa (5 bara). Accordingly, the second chamber 112 is pressurized to a pressure of 0.6 MPa (6 bara) and 5 MPa (5 bara).

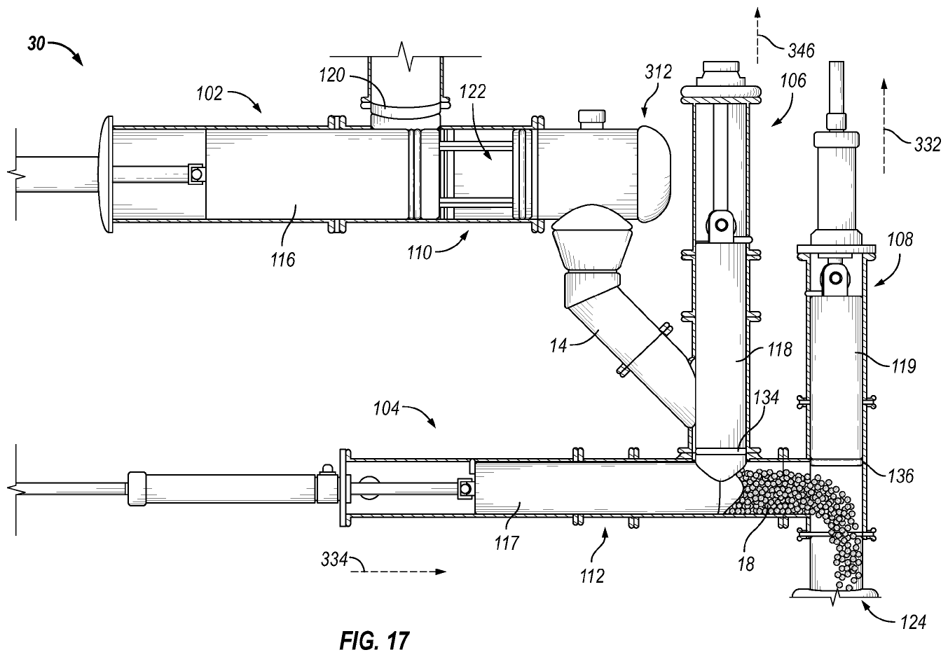

Returning to FIG. 13, the method includes feeding the solid feedstock to a dosing tank (block 330). To feed the solid feedstock 18 into the dosing tank (e.g., the dosing tank 32), the fourth piston 108 moves away from the outlet 124 while the third piston 106 remains in place to maintain the second chamber 112 isolated from the first chambers 110, 122 and the conduit 114, as shown in FIG. 17. Movement of the fourth piston 108 in the direction 332 releases the force (e.g., the forces 226, 250) from the pressure seal 136, which opens and allows fluid communication between the second chamber 112 and the dosing tank via the outlet 124. The barrel 117 of the second piston 104 moves within the second chamber 112 in a direction 334 toward outlet 124 to move the solid feedstock 18 into the dosing tank. As should be noted, the pistons 104, 108 may move simultaneously or in series. For example, in one embodiment, the third piston 106 moves in the direction 334 as the fourth piston 108 moves in the direction 332. In other embodiments, the fourth piston 108 moves in the direction 332 first to allow fluid communication between the second chamber 112 and the outlet 124, followed by movement of the second piston 104 in the direction 334 to feed the solid feedstock 18 into the dosing tank.

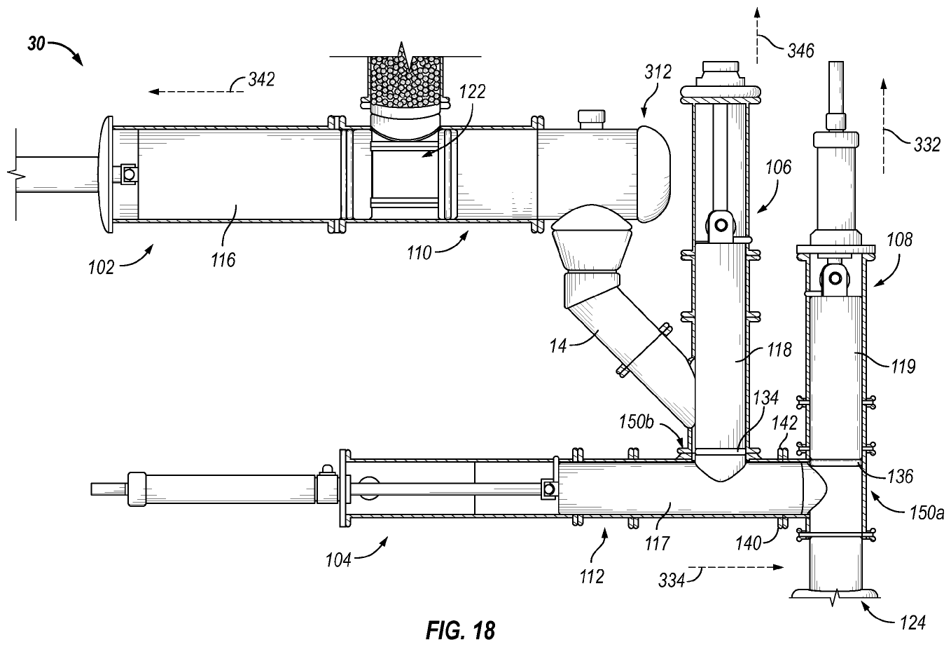

Once the solid feedstock 18 is fed to the dosing tank, the piston feeder 30 may receive another batch of the solid feedstock 18. For example, returning to FIG. 13, the method 300 includes aligning the feed chamber with the inlet of the piston feeder (block 340). The step may be done after or during the acts of block 330. In certain embodiments, the acts of block 340 may be done simultaneously with the acts of block 318. During alignment of the feed chamber 122 and the inlet 124, the first piston 102 moves in a direction 342 away from the terminus 312 of the first chamber 110 and toward the inlet 124 (see FIG. 18). The pistons 104, 106, 108 remain in place to keep the first chamber 110 and the conduit 114 isolated from the second chamber 112, the outlet 124, and the dosing tank. In this way, flow back of the solid feedstock 18 in the dosing tank may be mitigated.

Following alignment of the feed chamber 122 with the inlet 124, the solid feedstock 18 is provided to the feed chamber 122 in accordance with the acts of block 304. The method 300 may be repeated for each batch of solid feedstock that is fed to the dosing tank. Before, during, or after each batch of solid feedstock 18 is provided to the feed chamber 122, the second piston 104 may move away from the fourth piston 108 and the outlet 124 in a direction substantially opposite from the direction 334 and the fourth piston 108 may move toward the outlet 124 in a direction substantially opposite from the direction 332. The third piston 106 remains in place such that the second chamber 112 remains isolated from the first chamber 110 and the conduit 114. The configuration of the pistons 106 and 108 block fluid communication between the second chamber 112 and the first chamber 110 and the outlet 124, respectively. While in this configuration, the purge valve 142 may be opened to release the H₂ and depressurized the second chamber 112. Once depressurized, the third piston 106 may move away from the second chamber 112 in a direction 346 to allow fluid communication between the first chamber 110 and the second chamber 112 (see FIG. 18). As should be noted, based on the arrangement of the pistons 106 and 108, the directions 332, 346 may be the same or different.

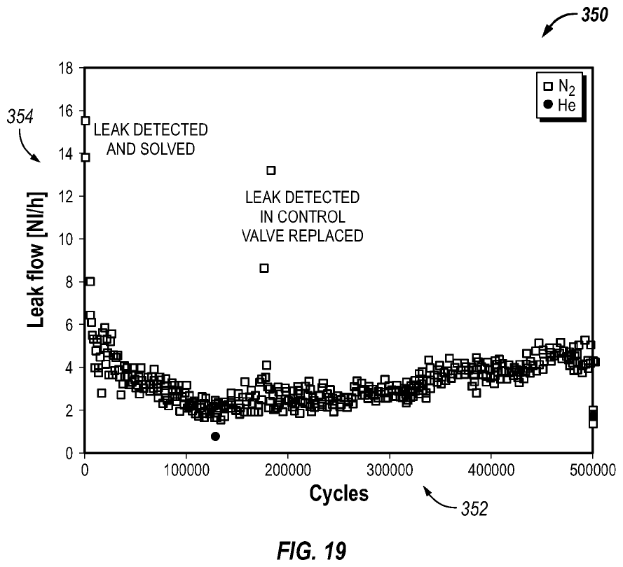

A piston having the seal and end portion configuration disclosed herein was tested for leakage. The leakage test was performed by pressurizing the piston and maintaining the pressure over a period of time. A reduction in pressure was measured during that time period, and the leakage rate was determined from the rate of pressure decrease. For example, the piston was pressurized to 41.5 bar. After 45 seconds, the pressure was measured every second for 300 seconds. A slope of a liner regression of the measured pressure was determined and the leak flow was calculated from the slope. The leakage test provides a good indication as to whether the piston maintains a seal for a desired number of cycles. The experimental setup included a piston having an end portion similar to that shown FIG. 10 and disposed in a housing. The piston was moved in cycles, each cycle including a downward movement (e.g., toward a sealing area adjacent to an outlet/terminal end of the housing) to activate the seal (e.g., cause the seal to linearly expand) and an upward movement (e.g., away from the sealing area and toward a housing opening opposite to the terminal end) to deactivate the seal (e.g., cause the seal to linearly retract). A pressure vessel pressurized with inert gas (e.g., nitrogen (N₂) or helium (He)) was positioned below the piston to measure the sealing ability of the seal. A pressure of the pressure vessel was observed for a period of time to estimate a leak rate of the inert gas and changes to the leak rate during the test. FIG. 19 is a plot 350 of number of cycles 352 as a function of leak flow 354 in normal liters/hour (NL/h) of a piston having the spring loaded end portion and seal disclosed herein (e.g., as shown in FIG. 10). As shown in the illustrated embodiment, the end portion and seal configuration disclosed herein maintained the seal for over 500,000 cycles without degradation and/or wear of the seal. The leakage flow was maintained between approximately 1 NL/h and approximately 6 NL/h, which is within specifications, and remained fairly steady throughout the 500,000 cycles. Conventional o-ring type seals that do not have the T-bar configuration of the seal disclosed herein begin to degrade/wear after approximately 20 cycles. In contrast the seal disclosed herein may go through 500,000 cycles or more without any observable degradation/wear and changes in leak rate.

As discussed above, the solid feedstock system disclosed herein may be used to provide a solid feedstock (e.g., biomass) to a reactor (e.g., a hydroprocessing reactor) in a manner that does not require large vessels and pressurized gas compared to lock hopper feeding systems used in commercial applications. The disclosed system and methods may also mitigate compaction of the solid feedstock that may affect the overall efficiency of hydroprocessing techniques and cost. The disclosed system and method use a unique configuration of pistons that transfer the feed through different chambers and into a dosing tank. Certain pistons of the piston feeder provide a seal that isolates chambers to facilitate pressurizing and mitigate flow back of the solid feedstock back into the piston feeder. The disclosed seal is designed in such a manner that mitigates damage caused by creep that may result in undesirable leakage and flow back of the solid feedstock from the dosing tank to the piston feeder. Additionally, the terminal end of the pistons having the disclosed seal have a beveled terminus such that the force applied by the terminus of the piston to the seal minimizes damage to the seal overtime.

The present disclosure may be embodied in other specific forms without departing from its spirit or essential characteristics. The described embodiments are to be considered in all respects only as illustrative and not restrictive. The scope of the disclosure is, therefore, indicated by the appended claims rather than by the foregoing description. All changes that come within the meaning and range of equivalency of the claims are to be embraced within their scope.

We claim:

1. A piston, comprising
a chamber; and
a barrel disposed in and configured to translocate within the chamber, wherein the barrel comprises a terminal end having a seal, and wherein the seal comprises an annular ring having a first wall and a second wall, wherein the second wall is orthogonal to and extends from the first wall such that a first portion of the first wall protrudes away from the second wall in a first direction and a second portion of the first wall protrudes away from the second wall in a second direction that is substantially opposite to the first direction.

2. The piston of claim 1, wherein the terminal end comprises a first plate, a second plate, and a third plate, wherein the third plate forms a terminus of the terminal end, and wherein the seal is disposed between the first plate and the second plate, and wherein the terminal end is configured to apply one or more forces on the seal to push at least a portion of the seal toward an inner surface of the chamber.

3. The piston of claim 2, wherein the first plate comprises a first surface, a first recessed wall, and first lip adjacent to the first recessed wall, the first recessed wall is circumferentially around the first surface and the first lip is around a circumference of the first plate, and wherein the second plate comprises a second surface, a second recessed wall, a second lip, and an interior wall extending from the second surface and positioned parallel to the second lip, the second lip is around a circumference of the second plate and the second recessed wall is disposed between the second lip and the interior wall and is circumferentially around the second surface.

4. The piston of claim 3, wherein the first portion of the first wall of the seal is disposed within the first recessed wall, the second portion of the first wall of the seal is disposed within the second recessed wall, the first wall abuts the interior wall, and the second wall of the seal is disposed between the first lip and the second lip.

5. The piston of claim 2, wherein the third plate has a beveled end having an angle of between approximately 35° and 50°.

6. The piston of claim 1, wherein the seal is an elastic incompressible material.

7. The piston of claim 1, wherein a cross-sectional geometry of the seal is T-shaped.

8. A solid feedstock feeding system, comprising:
a piston feeder configured to receive a solid feedstock and comprising an inlet, an outlet, and at least one piston disposed between the inlet and the outlet, wherein the at least one piston comprises:
a chamber; and
a barrel disposed in and configured to translocate within the chamber, wherein the barrel comprises a terminal end having a seal, and wherein the seal comprises an annular ring having a first wall and a second wall, wherein the second wall is orthogonal to and extends from the first wall such that a first portion of the first wall protrudes away from the second wall in a first direction and a second portion of the first wall protrudes away from the second wall in a second direction that is substantially opposite from the first direction.

9. The solid feedstock feeding system of claim 8, wherein the terminal end comprises a first plate, a second plate, and a third plate, wherein the third plate forms the terminus of the terminal end, wherein the seal is disposed between the first plate and the second plate, and wherein the terminal end is configured to apply one or more forces on the seal to push at least a portion of the seal toward an inner surface of the chamber.

10. The solid feedstock feeding system of claim 9, wherein the first plate comprises a first surface, a first recessed wall, and a lip adjacent to the first recessed wall, the first recessed wall is circumferentially around the first surface and the first lip is around a circumference of the first plate, and wherein the second plate comprises a second surface, a second recessed wall, a second lip, and an interior wall extending from the second surface and positioned parallel to the second lip, the second recessed wall is disposed between the second lip and the interior wall and is circumferentially around the second surface.

11. The solid feedstock feeding system of claim 10, wherein the first portion of the first wall of the seal is disposed within the first recessed wall, the second portion of the first wall of the seal is disposed within the second recessed wall, the first wall abuts the interior wall, and the second wall is disposed between the first lip of the first plate and the second lip of the second plate.

12. The solid feedstock feeding system of claim 9, wherein the third plate has a beveled end, and wherein an angle of the bevel is between approximately 35° and 50°.

13. The solid feedstock system of claim 9, wherein the seal is a thermoplastic material.

14. The solid feedstock system of clam 9, wherein a cross-sectional geometry of the seal is T-shaped.

15. The solid feedstock system of claim 9, comprising a second piston disposed upstream from the at least one piston, wherein the second piston comprises a second chamber and a second barrel disposed and configured to translocated within the second chamber, wherein the second barrel comprises a second terminal end having a top plate, a middle plate, a bottom plate, and a second seal disposed between the top plate and the middle plate, and wherein the second seal has a cross-sectional geometry that is T-shaped.

16. The solid feedstock feeding system of claim 9, comprising a dosing tank disposed downstream from and fluidly coupled to the piston feeder, wherein the dosing tank comprises a housing having one or more inlets, and one or more outlets, wherein at least one inlet of the one or more inlets is fluidly coupled to the outlet of the piston feeder and configured to receive the solid feedstock from the piston feeder and to provide the solid feedstock to a pressurized reactor, wherein the at least one piston is positioned adjacent to the one or more inlets of the dosing tank and is configured to isolate a portion of the piston feeder from the dosing tank.

17. A system, comprising:
a solid feedstock feeding system comprising a piston feeder configured to receive a solid feedstock and comprising an inlet, an outlet, at least one piston disposed between the inlet and the outlet, wherein the at least one piston comprises:
a first chamber; and
a barrel disposed in and configured to translocate within the first chamber, wherein the barrel comprises a terminal end having a seal, and wherein the seal comprises an annular ring having a first wall and a second wall positioned orthogonal to and extending from the first wall such that a first portion of the first wall protrudes away from the second wall in a first direction and a second portion of the first wall protrudes away from the second wall in a second direction that is substantially opposite from the first direction;
and
a reactor disposed downstream from and fluidly coupled to the solid feedstock feeding system, wherein the reactor comprises one or more inlets configured to receive the solid feedstock and to generate a product stream.

18. The system of claim 17, wherein the terminal end comprises a first plate, a second plate, and a third plate, wherein the third plate comprises a beveled end and forms a terminus of the terminal end, wherein the seal is disposed between the first plate and the second plate, and wherein the terminal end is configured to apply one or more forces on the seal to push at least a portion of the seal toward an inner surface of the first chamber.

19. The system of claim 17, wherein the seal is a thermoplastic material, and wherein a cross-sectional geometry of the seal is T-shaped.

20. The system of claim 17, wherein the at least one piston is disposed adjacent to the outlet of the piston feeder and configured to isolate the outlet and the reactor from one or more second chambers of the piston feeder disposed upstream of the first chamber.

21. The system of claim 17, comprising a dosing tank disposed downstream from the piston feeder and upstream from the reactor, wherein the dosing tank comprises a housing having one or more inlets fluidly coupled to the outlet of the piston feeder, and one or more outlets fluidly coupled to the one or more inlets of the reactor.
